(19) United States
(12) Patent Application Publication
(10) Pub. No.: US 2023/0410023 A1
(43) Pub. Date: Dec. 21, 2023

(54) GENERATING AN INTELLIGENT SUMMARY GRAPH AND TEXT FROM QUALITATIVE REVIEWS

(71) Applicant: INTERNATIONAL BUSINESS MACHINES CORPORATION, ARMONK, NY (US)

(72) Inventors: Balaji Kadambi, Bangaluru (IN); Sharath Kumar Rudrapatna Krishnarao, Bangalore (IN); Muralidhar Chavan, Bangaluru (IN); Manjula Golla Hosurmath, Bangalore (IN)

(21) Appl. No.: 17/806,995

(22) Filed: Jun. 15, 2022

(51) Int. Cl. G06Q 10/06; G06Q 30/02; G06F 40/242

(52) U.S. Cl. CPC G06Q 10/06395; G06Q 30/0201; G06F 40/242

(57) ABSTRACT

A method, computer system, and a computer program product for providing an automated graphical and textual review summary of user submissions has been provided. In one embodiment this comprises obtaining a plurality of user submissions relating to a particular subject matter and having information relating to this subject matter. Extracting at least one feature and feature review relating to each of the user submissions and generating statistical insights relating to these features and features reviews and other relevant information relating. A summary review is then generated relating to these user submissions. The summary review includes information about each feature, feature review and statistical insights.

### BACKGROUND

The present invention relates generally to the field of data analysis and more particularly to techniques for generating graphical output from qualitative input reviews.

It may be important for every business to assess strengths and weaknesses. An objective analysis of these strengths and weaknesses allows the business to succeed by improving processes that require change. It may be easier to address weaknesses in areas of the business that have concrete measurements. For example, the need to replace a particular machine or improve on the overall efficiency of a process may be easier to compare against a target measurement. However, it may be more difficult to measure customer satisfaction and reasons behind a successful or unsuccessful engagement with a particular customer.

When it comes to customer satisfaction, many businesses rely on customer input or satisfaction surveys. With the advent of technology, an online presence for a business has become common. In the past, many customers would interact face-to-face with the business and provide their feedback. However, business processes have evolved such that most transactions occur without a face-to-face interaction. This has increased the need for businesses to stay connected with consumers in a way that the business can understand customer's needs and their expectation and view of the business both before and after the transaction has been completed. One important way to stay connected may be by taking feedback and reviews from customers digitally, and then acting on them. The feedback from customers can be made in the form of a qualitative review or quantitative review or involve elements of both functions. Once any feedback has been taken and provided, however, the business has to use the information given in a manner that improvements can be made. This can be a very challenging area for many businesses, especially as they grow and the amount of feedback and the channels through which these feedbacks may be provided increase quickly.

### SUMMARY

Embodiments of the present invention disclose a method, computer system, and a computer program product for providing an automatic review summary of user submissions. In one embodiment this comprises obtaining a plurality of user submissions relating to a particular subject matter and related information relating to this subject matter; and extracting at least one feature and at least one feature review relating from the user submissions. Subsequently, statistical insights relating to the extracted features and features reviews and other related information is generated. A summary review will then also be generated. The summary review includes information about each feature, feature review and statistical insights. In one embodiment, a summary review graph may then be generated from the summary review. In another embodiment, the extraction of the feature and feature review may be conducted by accessing an intelligent dictionary database. In another embodiment, an automated textual summary is generated by traversing the summary review graph.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart illustrating generation of a review summary from a plurality of user submissions according to at least one embodiment;

FIG. 3 provides a block diagram showing one example with different user submission scenarios according to one embodiment;

FIG. 4 provides an illustration of embodiments of FIG. 2 and example of FIG. 3 combined into a block diagram according to one embodiment;

FIG. 5 provides a block diagram of internal and external components of computers and servers depicted in FIG. 1 according to at least one embodiment;

FIG. 6 provides a block diagram of an illustrative cloud computing environment including the computer system depicted in FIG. 1, in accordance with one embodiment; and

FIG. 7 provides a block diagram of functional layers of the illustrative cloud computing environment of FIG. 6, in accordance with an embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but may not be limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and computer program product for providing an automatic review summary of user submissions has been provided. In one embodiment this comprises obtaining a plurality of user submissions relating to a particular subject matter and having information relating to this subject matter and extracting least one feature and feature review relating to each of the plurality of user submissions from the information. Subsequently, generating statistical insights relating to said plurality of features and features reviews and other information relating to the user submissions; and ultimately generating a summary review pertaining to said plurality of user submissions. The summary review includes information about each feature, feature review and statistical insights. In one embodiment, a summary review graph may then be generated from the summary review. In another embodiment, the extracting of the feature and feature review may be conducted by accessing an intelligent dictionary database.

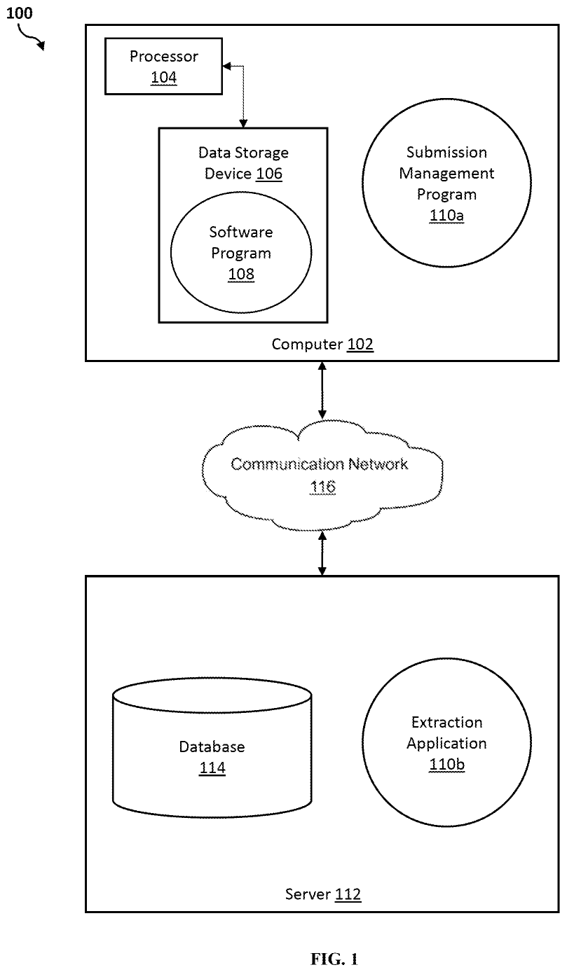

FIG. 1 provides an exemplary networked computer environment 100 in accordance with one embodiment. The networked computer environment 100 may include a computer 102 with a processor 104 and a data storage device 106, enabled to run a software program 108 and a submission management program 110a. The networked computer environment 100 may also include a server 112, enabled to run an extraction application 110b that may interact with a database 114 and a communication network 116. The networked computer environment 100 may include a plurality of computers 102 and servers 112, only one of which has been shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

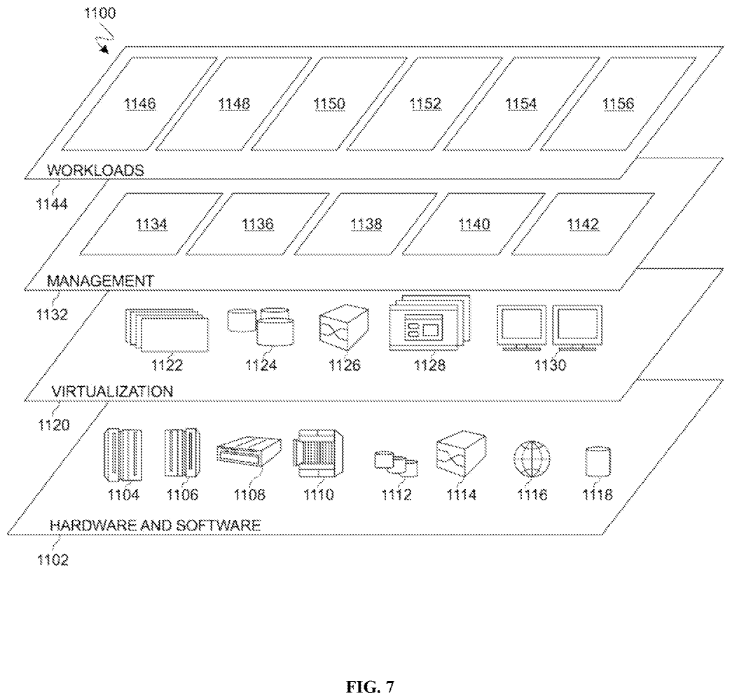

The client computer 102 may communicate with the server computer 112 via the communications network 116. The communications network 116 may include connections, such as wire, wireless communication links, or fiber optic cables. As will be discussed with reference to FIG. 7, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as an exclusive cloud, community cloud, public cloud, or hybrid cloud. Client computer 102 may be, for example, a mobile device, a telephone, a customized digital assistant, a netbook, a laptop computer, a tablet computer, a desktop computer, or any type of computing devices capable of running a program, accessing a network, and accessing a database 114. According to various implementations of the present embodiment, review submission management program 110a, and an extraction application 110b may interact with a database 114 that may be embedded in various storage devices, such as, but not limited to a computer/mobile device 102, a networked server 112, or a cloud storage service.

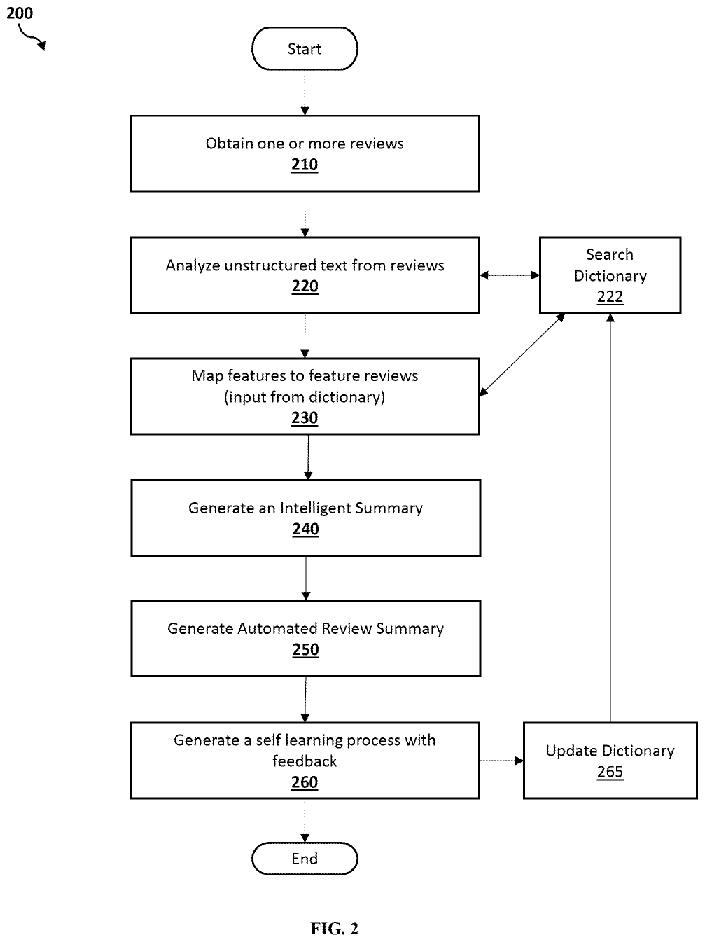

According to the present embodiment, a user using a client computer 102 or a server computer 112 may use the program/application 110a, 110b (respectively) to provide a user review submission and feature extraction technique. This technique will be provided in more detail below with respect to FIGS. 2 through 4.

Referring now to FIG. 2, a flowchart depiction for techniques to generate a review summary for a plurality of user submissions has been provided. This technique 200 provides a quick way to provide businesses with emerging trends and issues so as to ensure continued and future business success.

In Step 210, a series of reviews may be obtained from a plurality of platforms. There may be several ways to obtain these reviews as known to those skilled in the art. The manner to obtain these reviews range from simple (the business sets up the platforms and these set up platforms may be periodically looked at automatically or otherwise to see if new reviews have been provided) to sophisticated and complex (an automatic system may be set up that searches many platforms online and may be alerted wherever and whenever a subject matter of interest or the business itself has been mentioned).

In Step 220, once these reviews have been obtained an analysis process commences. In other words, unstructured text from each of the reviews may be examined and relevant information is extracted. In one embodiment, as shown at Step 222, the analysis may involve using an Intelligent Dictionary residing in a database.

The dictionary often includes rules and policies that will be useful in analyzing the responses that may be obtained. The process of creating the dictionary, in most situations has already started prior to current analysis and obtaining of the responses. However, new entries can be added any time for use with the current or future analysis. For example, in a particular instance, a new rule can be added that will be useful for a current analysis. The dictionary can then be either static or dynamic accordingly.

In one embodiment, the intelligent dictionary may be generated for every domain. The dictionary can have any type of information stored as per customer needs. This list can be exhaustive, but some examples can be provided for ease of understanding:
Parts of speech (POS) chunk grammar rules to extract “feature” and “feature review” for a domain. (A domain can be “car,” camera” or can be fine grained to include a brand and model—“Sony camera 200D”).
Synonymous words for “feature” and “feature review” for a domain.
“Feature review” values (or patterns) for a “feature” in a domain. For example—“12 kmpl” refers to “mileage” in a car domain.
Reviewers and reviewer rating—the list of expert reviewers may be maintained. A “feature review” from an expert may be given more weightage.
A list of unique but important features list. This may be to ensure that this feature can be extracted from even badly formed sentences which the Natural Language Processing (NLP) model can fail to extract.

Once the dictionary has been consulted, the process (Step 220) may then be able to analyze any unstructured texts from each of the reviews in order to extract “features” and the “feature reviews” as part of the analysis and extraction process. In one embodiment, this may entail using a rule based NLP model that can analyze the reviews and perform the extracting. As mentioned earlier, the NLP model will use the dictionary that has all domain specific rules and information to complete this process. In addition, the model may use multiple rules or POS chunk grammar from the dictionary for the domain to capture these features and feature reviews. For example:
Nouns (NNINNSINNPSINNP) followed by (JJIJJRJJS)
adjectives followed by nouns and adjectives
concatenation of two nouns followed by adjectives
multiple nouns and multiple adjectives etc. as per the below examples.

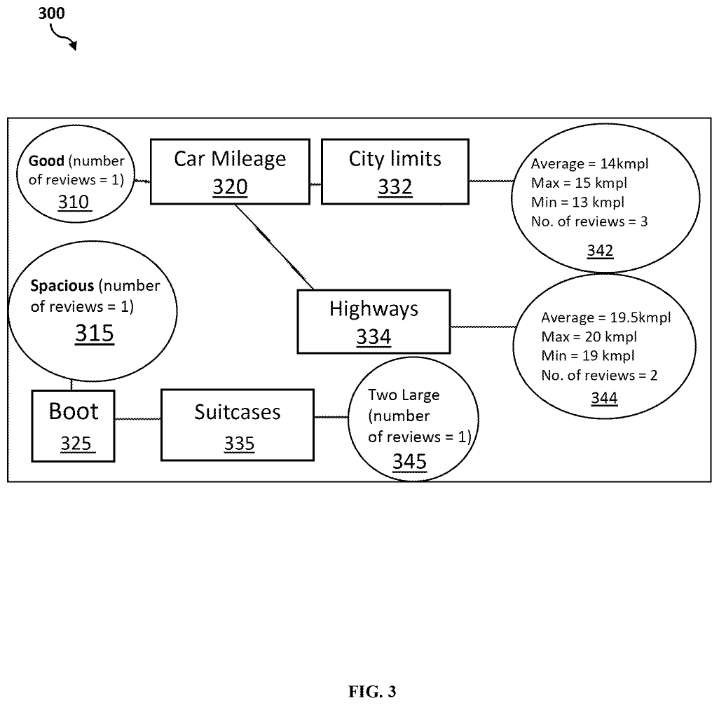

In another example, the extracted information may include information about a particular feature of the business. In FIG. 3, a scenario may be explored in a business that involves cars. Using that scenario, the information may then involve “The car mileage is good with 12 kmpl within city limits and 20 kmpl on highways.” In this example, the POS tagging may be done using an NLP toolkit as shown at 435 that may give the output below:
[(‘The’, ‘DT’). (‘car’, ‘NN’), (‘mileage’, ‘NN’). (‘is’, ‘VBZ’), (‘good’, ‘JJ’). (‘with’, ‘IN’), (‘12 kmpl’, ‘CD’), (‘within’, ‘IN’), (‘city’, ‘NN’), (‘limits’, ‘NNS’), (‘and’, ‘CC’), (‘20 kmpl’. ‘CD’), (‘on’. ‘IN’), (‘highways.’, ‘NN’)]

In the above sentence, the model may extract:
The feature as “car mileage” and “feature review” as good.
The feature as “city limits” and “feature review” as 12 kmpl.
The feature as “highways” and “feature review” as 20 kmpl.

The first two nouns (NN) may be concatenated to generate a feature and describe it with an adjective (JJ) as good. Similarly, the other sub-features may be extracted with combinations of other parts of speech (NN|NNS for sub-feature and CD for “feature review”).

In another example, the response may include “The leg room is good. The boot space is adequate for two large suitcases.” This may lead to the following extraction:
[(‘The’, ‘DT’), (‘leg’, ‘NN’). (‘room’, ‘NN’). (‘is’, ‘VBZ’), (‘good.’, ‘JJ’), (‘The’, ‘DT’), (‘boot’. ‘NN’), (‘space’, ‘NN’), (‘is’, ‘VBZ’), (‘adequate’, ‘JJ’), (‘for’, ‘IN’), (‘two’, ‘CD’), (‘large’, ‘JJ’). (‘suitcases.’. ‘NNS’)]

In this example, two features may be detected. The first one is the leg room (NN+NN) and the second one is boot or trunk space (NN+NN) and the corresponding adjectives (JJ) describing the feature. Also, we can use the cardinal digit (CD) to identify the feature name—i.e. if the CD is two digits, then the feature is mileage/fuel efficiency, if the CD is 4 to 5 digits, then the feature could be tires.

In Step 230 the mapping of the features and feature reviews may be performed. In the example used above the “feature review” value can be used to map the “feature” based on dictionary input. The mapping involves the calculation of a score based on worthiness of the feature or feature review. In addition, the score calculation also includes the filtering out of the less important features or incorrectly identified features (using the “feature worthiness” score). The “feature worthiness” may be determined based on any factors as will be later discussed in detail. For example, it may depend upon the frequency of occurrence, rules specified for the feature in the dictionary and other customized parameters. In one embodiment, for example, if the feature/feature review may be a unique feature with less than two comments, then that feature may be included in the “Dictionary” for the feedback & self-learning process. Such features have a high “feature worthiness” score once entered in the Dictionary.

Another aspect of calculating worthiness, as mentioned may involve the need to identify features that may be the same or similar but worded differently. (i.e.—Out of 10 reviews, 4 people would have mentioned about car mileage, 2 would have said fuel efficiency, 1 would have said fuel consumption etc. but they all convey same concept). In this case, the feature name would be mileage given the higher count of mentions. The other synonymous words may be maintained in a “Dictionary” for the domain.

In one embodiment, the sentiment of the reviews may need to be extracted. For example, in a scenario, two reviews have been obtained:
“The car mileage is good. The pickup is good.” and
“The build quality is bad. This can definitely bring someone's life at stake.”

In the above example, the system may extract features like mileage, pickup & build quality. The insights would be stating that mileage and pickup may be good (positive sentiment) however build quality may not be good which may be a negative sentiment.

In Step 240, an Intelligent Summary may be generated. This summary may be generated using qualitative user reviews(s) and statistical insights as well as other text features. The qualitative user reviews provides information about different features of each review (for example if each review was positive or negative). The statistical insights can include information about all the reviews or even information from outside to give more relevance to the issues (such as general reviews of all 1999 BWMs are 54 percent positive but these reviews are 34 percent positive).

In one embodiment, this may be a summary that can be visual based such as a graph. The features of the summary can be customized to include a list of different items such as reviews and statistical insights. In one embodiment, output from the previous step of mapping (a map of “feature” and “feature review”, sentiments, etc.) may be used to compute statistics. Then the visual effect, such as the graph may be built with all this information. In one embodiment, this can also be audio-visual and interactive so that other information can be requested and added dynamically as per user request.

In Step 250, an automated Review Summary may be generated. In one embodiment, this may be generated with insights based on the summary and/or summary graph and user requested information. As indicated, when this may be interactive, an audio or audio visual includes the new requested information as well.

In Step 260, in one embodiment, artificial intelligence or machine learning or other self-learning process may be included that also includes feedback. This can provide, for example, new context or interpretations of certain text when processing so better future processing can be conducted. In Step 265, the dictionary may also be updated based on the user or business's feedback. This ensures more accurate results during the subsequent runs in the future.

FIG. 3 provides an example to provide ease of understanding. In FIG. 3, the business is a car dealership or alternatively a car manufacturer, that receives car reviews for a particular model for a brand of car. In this scenario, there may be hundreds or thousands of reviews that may be received through many channels for the particular model in question. To the business, a quick overview that summarizes customer sentiments regarding different features of the car and the particular model maybe very useful. To understand the comments quicker and get an idea of the important features, sometimes graphical illustrations may be easier to understand through their many key visual components. A summary which can be visualized may give an idea about the feature, “feature review” and what percentage of users feel that way about the feature. This can be an intelligent graph that holds information. In this scenario, there may be at least 1000 reviews but the graphical illustration provides the essence of customer sentiments in a way that the business may be able to provide a business decision that provide a right direction for their needs going forward.

In this scenario, some of the information provided below as an example may be used to generate a summary report and a graph. As summary objective text may be first provided as below:
There were six user reviews.
The car mileage has been reviewed as good by 17% of the reviews.
The boot has been reviewed as spacious by 17% of the reviews.
The city limits of car mileage feature has been reviewed with maximum 15 kmpl, minimum 13 kmpl and an average of 14 kmpl by 50% of reviews.
The highways of car mileage feature has been reviewed with maximum 20 kmpl, minimum 19 kmpl and an average of 19.5 kmpl by 34% of reviews.
The suitcases of boot feature has been reviewed as two large by 17% of reviews.”

At least part of the information provided by the users above can go into making the graphical illustration 300 of FIG. 3. The amount of information provided may be customized by customer needs. For example, different scenarios may exist that provide all of the user's reviews in a graph or provide some of them as per a need/function or customization. For example, the comment about “The highways of car mileage feature has been reviewed with maximum 20 kmpl, minimum 19 kmpl and an average of 19.5 kmpl by 34% of reviews” may be provided graphically through the figures marked 310, 320, 334, and 344. In this branch of the graph, this may indicate that the was at least one good review that indicated comments about the car mileage on highways and then provided the actual details about the mileages (as an average and maximum/minimum). Another branch that of 315, 325, 335 and 345 provide information captured by “The suitcases of boot feature has been reviewed as two”. Another branch may yet take it through 310, 320, 332 and 342 that include city rather than highway driving with different averages and maximum/minimum mileage.

To understand some of the concepts that will be used in one embodiment to develop a summary that can be used visually if preferred such as in a graphical presentation, some of the concepts can be described below for ease of understanding. It should be understood, however that the summary can be used in several different and alternate manners besides being visually available and that the terminology below may only be to assist understanding and variations of it may be possible as can be appreciated to those skilled in the art.

The first terminology to discuss has to do with the term “review text” which indicates text that contains review of the product or service from a source such as a user. The “review text” can contain many sentences and paragraphs. For example, in one scenario the sentence “The mileage is 12 kmpl.” may be designated as a “review text” which may provide certain “feature(s)” and “feature review(s)”. In this example—“Mileage” is a “feature” and “12 kmpl” is a “feature review.” A “feature review” in this context may be a qualitative or quantitative opinion about the feature. In one embodiment, the review text may be used as one component to build an intelligent summary visual aid (like a graph). This summary may then be further utilized to generate automation text in some embodiments.

Once a plurality of reviews has been provided to one or more platforms that collect them, the features can be extracted. In one embodiment, the extraction of the “feature” or “feature review” can be performed from every sentence in the reviews submitted to the platforms. Rules can be set up to provide this extraction easier. For example, a set of rules may be set up that defines these policies:
A “feature” is a noun in combination with other parts of speech.
A “feature review” is an adjective in combination with other parts of speech.

In one embodiment, the “features” may also have a particular hierarchy. For example, in the scenario of FIG. 3, the word “mileage” relating to a car can be within “city limits” or “highways”. The “city limits” and “highways” may be sub-features, and “mileage” may be the parent feature. The numerals provided in FIG. 3 provide the concept of this hierarchy (320 numerals higher in order than 330 numerals etc.) It should be noted that all references and statements provided herein as relating to features also apply to sub features.

In one embodiment, to provide the feature in the summary the “features” value or worthiness may be evaluated. In one scenario, the features worthiness may rise if many reviews may be submitted that include the feature. Also, a feature worthiness may be given more weight and flagged as more worthy provided depending on the source. For example, a certain platform or an expert may provide more weight. In one embodiment, the “feature” worthiness may be provided with a score that may be later used to determine if the feature should be part of the summary.

In the same manner, the “feature review” can also be provided with a weight or worthiness score. A “feature review” may be given more weight, for example, in a scenario where it may be provided from an expert or a particular platform. The weight may also be provided as part of a customization or according to a particular value calculation. For example, a particular platform or experts belonging to an organization may be given a score that may be a multiple (e.g., 100 times) of the weight given by a regular user. There may be a hierarchy of scores (such that another platform has a weight of only 50 instead of 100) in this calculation.

In one embodiment, similar or same features provided by the reviews can also be merged for the summary. For example, in a scenario that includes “fuel efficiency” and “mileage”, both phrases may be used to indicate similar thoughts as relating to a car. In this situation, both of these phrases may be considered as the same during analysis process and be merged. In a different example, the words used such as “good” and “nice” may mean the same given the context for a “feature review” and consequently they will also be merged into one category for generating the summary.

In one embodiment, the feature and feature reviews may be mapped to one another. In on embodiment, there may be several rules or policies that govern this mapping. For example, in one embodiment, the “feature review” may be mapped to the feature that occurs immediately before it. Also, domain specific rules may exist that map a “feature review” to a “feature” based on the value. For example, using the scenario of FIG. 3, “12 kmpl” refers to mileage in the automobile domain used, while “30 psi” refers to tire pressure, etc. In one embodiment, similar concepts may be applied to deciding not to extract a feature or flagging it as more of a “feature value”. For example, consider the statement—“It gives 12 kmpl within city.”. In this example, the statement more appropriately relates to the mileage based on a domain rule.

In one embodiment, during the calculation and scoring of each feature, statistics and features may be computed for each feature and feature reviews submitted. In at least one embodiment, some statistics may be readily available (such as number of reviews, number of reviews that have a “feature review” for a “feature” etc.).

This information may then be used according to at least one embodiment to construct and generate an intelligent summary, such as one that includes visual aids like graphical representations, with all the extracted features and feature reviews selected using the statistics and other computational and analysis procedures. In one embodiment, a lot of different types of information can be selected, and the statistics used can be customized to build the intelligent summary (graph). With the advent of availability and access to big data lakes these features can be further expanded and even used in conjunction with machine learning. The list of these items selected for analysis and statistical use may be exhaustive, but a few examples will be provided below only for ease of understanding of some of their nature:
Number of reviews;
Percentage of reviews for a feature;
Percentage of positive sentiment reviews or negative sentiment “feature reviews (qualitative —good, nice, bad etc.)” for a “feature”;
Max, min, median and average values for a quantitative “feature review”. For example —“mileage” for a car within “city limits”; and
Only the sentences that talk about a “feature” from “review text” (this can be a verification to see if the “feature” and “feature review” have been correctly extracted and then provide feedback to the system).

Referring back to FIG. 3, in one embodiment, the final summary generated can include ways of connecting information to one another. In the graphical illustration of FIG. 3, the summary graph includes a plurality of nodes (referenced by the shapes shown and numerals such as 310, 320, 332, 342 etc.). In one embodiment, there may be a variety of different types of nodes—“feature,” “feature review,” “statistics,” etc. and as shown these nodes may also be linked to each other.

In one embodiment, one or more algorithms may be used to read the summary and/or graphical illustrations to also generate further information such as additional sentences for providing an automated summary (traverse graph to generate sentences.)

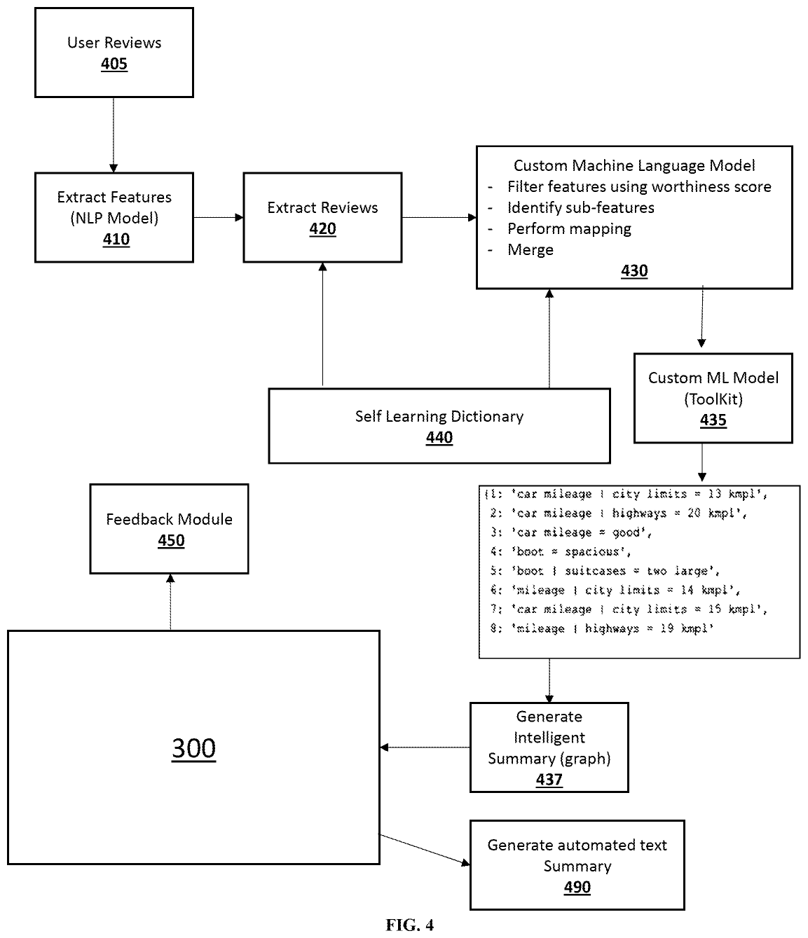

FIG. 4 provides an illustration of an overall system where the concepts of FIGS. 2 and 3 may be combined. The box with numerals 300 provides exact specifics as provided in the scenario and example of FIG. 3. These specifics may be provided below:

To ease understanding, the embodiment provided in FIG. 4 uses an exemplary scenario with 6 provided reviews. Using the specifics of the example provided in FIG. 3, some other concepts were as follows—
There were six user reviews, and the reviews were as follows.
Review 1—“The car mileage is 13 kmpl within city limits and 20 on highways”.
Review 2—“The car mileage is good”.
Review 3—“The car gives a mileage of 14 kmpl with city limits and 19 kmpl on highways”.
Review 4=“The trunk is spacious”.
Review 5—“The boot can hold two large suitcases”.
Review 6—“the car mileage was 15 kmpl within the city”.

As illustrated at 410 and 420, once the user reviews 405 may be obtained the features and reviews may be extracted. In one embodiment an NLP model may be used for this extraction. This may include NLP extracting the features from every sentence of the review text based on the feature extraction chunk grammar (specified for the domain in the self-learning Dictionary at 440). An NLP model will extract the “feature review” from every sentence of the review text based on the “feature review” extraction chunk grammar (specified for the domain in the Dictionary 440), and other domain specific rules based on value of the “feature review”.

In this scenario, a Machine Learning Model illustrated at 430 (hereinafter ML model) may determine the feature worthiness score (between 0 and 1) of extracted features based on various parameters like frequency of occurrence of the features in reviews, uniqueness, reviewer rating (expert reviewer gets higher rating) and other parameters specified in the Dictionary. Here, the features that have a “feature worthiness score” less than, for example, 0.6, can be removed from the list for accuracy. The corresponding “feature reviews” may be also removed from the list. In this example, the ML model may identify sub-features in the features extracted from a sentence. The sub-features may be first extracted based on the values in the dictionary. Otherwise, if there are two features in a sentence, the second feature may be taken as a sub-feature of the first feature. It will then create a map of a feature, sub-feature (if any) and “feature review”.

The model will merge the features that are the same but are worded differently. This may be done based on text similarity and synonymous words specified in the Dictionary 440. For example, “boot” and “trunk” are different ways that regional/countries define the same space. In another example, “car mileage,” “mileage,” and “fuel efficiency” are talking about the same feature.

During this process the Dictionary 440 may be used. In one embodiment, the dictionary defines domain categories. It also defines POS chunk grammar rules for “feature” and “feature review” extraction for each domain ((Example—{<JJ|JJR|JJS>*?<NN|NNS|NNPS|NNP>*}, {<JJ|JJR|JJS>}—or {<CD>NN|NNS>}, {<CD><JJ>}). As stated above and in the example of boot/trunk, the dictionary can also extract and define synonymous feature words and “feature review” words for a domain. The input for this can include “meta-data” about the product. In one embodiment, a list of reviewers and reviewer ratings may also be created. This created list may be unique but may include an important feature list for the domain. The input for this may include “meta-data” about the product. From this information a list of sub-features for a domain may also be created.

It should be noted that the feedback module 450 can provide additional information iteratively using the reviews and statistical insights (box 300) to update the dictionary 440 as was discussed in FIG. 2.

The Output of this process may be used by custom ML model 430 to ultimately generate an intelligent summary review 437 (graph when appropriate) that has the features, reviews and statistical insights as discussed earlier. Custom ML may also provide and generate of a map between “feature” and “feature review”. In some embodiments, custom ML also generates statistics on percentage of reviews for a feature, review sentiment (positive or negative) and more. This may also lead to building an intelligent summary graph which will have a brief description of the product, features, “feature reviews” and other insights. In some embodiments, the custom machine language model 435 (which can include one or more custom Toolkits) as shown at 435 may be used (i.e., Python NLTK).

This ultimately may lead to construction of an intelligent summary review (graph) 437, as described previously with respect to Step 240 above, and an automated review summary that incorporates an algorithm that may traverse the “intelligent summary graph” to generate a summary of the reviews with insights. In one embodiment, when a summary graph is generated an automated text summary 490 can also be generated as discussed.

The feedback module and self-learning 450 may be an iterative process as discussed earlier. In one embodiment, the feedback may be provided based on the extracted features and “feature review”. This feedback may be incorporated at every step:
(a) Dictionary update—POS chunk grammar for the domain to extract “feature” and “feature review”, Synonymous features and “feature review”, unique features, etc. for a domain.
(b) NLP models that extract “feature” and “feature review”
(c) The ML model that filters features using “feature worthiness score” and other criteria
(d) The ML model that identifies sub-features, and creates a map between “feature” and “feature review”
(e) The ML model that merges features that are same

The end result may provide:
The car mileage has been reviewed as good by 17% of the reviews.
The boot has been reviewed as spacious by 17% of the reviews.
The city limits of car mileage feature has been reviewed with maximum 15 kmpl, minimum 13 kmpl and an average of 14 kmpl by 50% of reviews.
The highways of car mileage feature has been reviewed with maximum 20 kmpl, minimum 19 kmpl and an average of 19.5 kmpl by 34% of reviews.
The suitcases of boot feature has been reviewed as two large by 17% of reviews.

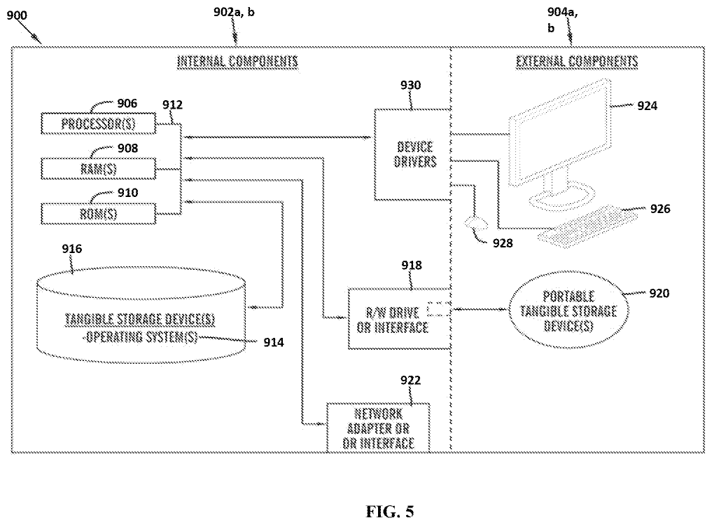

FIG. 5 provides a block diagram 900 of internal and external components of computers depicted in FIG. 1 in accordance with an illustrative embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

Data processing system 902, 904 may be representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but may not be limited to, individual computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 7. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the review submission management program 110a in client computer 102, and the extraction application 110b in network server 112, may be stored on one or more computer-readable tangible storage devices 916 for execution by one or more processors 906 via one or more RAMs 908 (which typically include cache memory). In the embodiment illustrated in FIG. 7, each of the computer-readable tangible storage devices 916 may be a magnetic disk storage device of an internal hard drive. Alternatively, each of the computer-readable tangible storage devices 916 may be a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108, the review submission management program 110a and the extraction application 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the review submission management program 110a in client computer 102 and the feature extraction application 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the review submission management program 110a in client computer 102 and the extraction application 110b in network server computer 112 may be loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It should be understood in advance that although this disclosure includes a detailed description on cloud computing, implementation of the teachings recited herein may not be limited to a cloud computing environment. Rather, embodiments of the present invention may be capable of being implemented in conjunction with any other type of computing environment now known or later developed.

Cloud computing provides a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics may be as follows:
On-demand self-service: a cloud consumer can unilaterally provision computing capabilities, such as server time and network storage, as needed automatically without requiring human interaction with the service's provider.
Broad network access: capabilities may be available over a network and accessed through standard mechanisms that promote use by heterogeneous thin or thick client platforms (e.g., mobile phones, laptops, and PDAs).
Resource pooling: the provider's computing resources may be pooled to serve multiple consumers using a multi-tenant model, with different physical and virtual resources dynamically assigned and reassigned according to demand. There may be a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models may be as follows:
Software as a Service (SaaS): the capability provided to the consumer may be able to use the provider's applications running on a cloud infrastructure. The applications may be accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer may be deployed onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer may be to provision processing, storage, networks, and other fundamental computing resources where the consumer may be able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models may be as follows:
Customized and Individual cloud: the cloud infrastructure may be operated solely for an organization. It may be managed by the organization or a third party and may exist on-premises or off-premises.
Community cloud: the cloud infrastructure may be shared by several organizations and supports a specific community that has shared concerns (e.g., mission, security requirements, policy, and compliance considerations). It may be managed by the organizations or a third party and may exist on-premises or off-premises.
Public cloud: the cloud infrastructure may be made available to the general public or a large industry group and may be owned by an organization selling cloud services.
Hybrid cloud: the cloud infrastructure may be a composition of two or more clouds (customized and individual, community, or public) that remain unique entities but may be bound together by standardized or proprietary technology that enables data and application portability (e.g., cloud bursting for load-balancing between clouds).

A cloud computing environment may be a service oriented with a focus on statelessness, low coupling, modularity, and semantic interoperability. At the heart of cloud computing may be an infrastructure comprising a network of interconnected nodes.

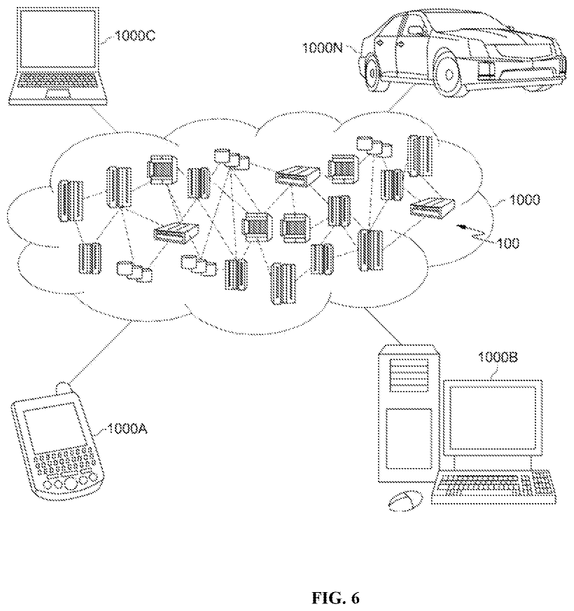

Referring now to FIG. 6, illustrative cloud computing environment 1000 may be depicted. As shown, cloud computing environment 1000 comprises one or more cloud computing nodes 100 with which local computing devices used by cloud consumers, such as, for example, digital assistants (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as exclusive, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It may be understood that the types of computing devices 1000A-N shown in FIG. 5 may be intended to be illustrative only and that computing nodes 100 and cloud computing environment 1000 can communicate with any type of computerized device over any type of network and/or network addressable connection (e.g., using a web browser).

Referring now to FIG. 7, a set of functional abstraction layers 1100 provided by cloud computing environment 1000 has been shown. It should be understood in advance that the components, layers, and functions shown in FIG. 6 may be intended to be illustrative only and embodiments of the invention may be not limited thereto. As depicted, the following layers and corresponding functions may be provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual exclusive networks; virtual applications and operating systems 1128; and virtual clients 1130.

In one example, management layer 1132 may provide the functions described below. Resource provisioning 1134 provides dynamic procurement of computing resources and other resources that may be utilized to perform tasks within the cloud computing environment. Metering and Pricing 1136 provide cost tracking as resources may be utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels may be met. Service Level Agreement (SLA) planning and fulfillment 1142 provide pre-arrangement for, and procurement of, cloud computing resources for which a future requirement may be anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and data management 1156.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing an automatic review summary of user submissions, comprising:
obtaining a plurality of user submissions relating to a particular subject matter and having information relating to said subject matter;
extracting at least one features and at least one feature review relating to each of said plurality of user submissions;
generating statistical insights relating to said plurality of features and features reviews and other related information relating from said user submissions; and
generating a summary review pertaining to said plurality of user submissions, wherein said summary review includes information about each feature, feature review and statistical insights.

2. The method of claim 1, wherein said extracting is performed by retrieving information from an intelligent dictionary database, wherein said dictionary has domain specific rules and policies for dealing with unstructured text submission.

3. The method of claim 2, wherein said dictionary provides chunk grammar information for analyzing unstructured text so as to extract features, feature reviews and feature values.

4. The method of claim 1, wherein said features and feature reviews are mapped together.

5. The method of claim 1, wherein each feature and feature review are provided with a worthiness score and said worthiness score determines which features and feature reviews are provided in said summary review.

6. The method of claim 5, wherein said worthiness score is calculated based on frequency, reviewer rating, and uniqueness of said features and feature reviews.

7. The method of claim 6, wherein one or more augmenting multiples can be given to a particular feature or feature review based on a source that said user providing said submission or said user submission source.

8. The method of claim 6, wherein one or more augmenting multiples can be given to a particular feature or feature review based on importance and/or uniqueness of said feature or feature reviews.

9. The method of claim 5, wherein same or synonymous feature and feature reviews are extracted and provided only once in said summary review.

10. The method of claim 1, wherein user reviews about same or synonymous features will include worthiness score of a feature or feature review.

11. The method of claim 1, wherein said user reviews can be obtained from a multiple of platforms.

12. The method of claim 1, further comprising generating a summary graph from said summary review.

13. The method of claim 12, wherein said summary graph presents relation between said feature(s) and said feature review(s) with statistical insights.

14. The method of claim 13, further comprising generating an objective automated summary to be provided with said summary graph, wherein said automated summary is generated by traversing through the intelligent summary graph to provide additional textual information.

15. The method of claim 12, wherein any information obtained in generating said summary graph that is deemed not to be in said dictionary is stored in said dictionary and said dictionary is update.

16. A computer system for providing an automatic review summary of user submissions, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
obtaining a plurality of user submissions relating to a particular subject matter and having information relating to said subject matter;
extracting at least one features and at least one feature review relating to each of said plurality of user submissions;
generating statistical insights relating to said plurality of features and features reviews and other related information relating from said user submissions; and
generating a summary review pertaining to said plurality of user submissions, wherein said summary review includes information about each feature, feature review and statistical insights.

17. The computer system of claim 16, wherein said extracting is performed by retrieving information from an intelligent dictionary database, wherein said dictionary has domain specific rules and policies for dealing with unstructured text submission.

18. The computer system of claim 16, further comprising generating a summary graph from said summary review.

19. The computer system of claim 18, each feature and feature review are provided with a worthiness score and said worthiness score determines which features and feature reviews are provided in said summary review and summary review graph.

20. A computer program product for providing an automatic review summary of user submissions, comprising:
one or more computer-readable storage medium and program instructions stored on at least one of the one or more tangible storage medium, the program instructions executable by a processor, the program instructions comprising:
obtaining a plurality of user submissions relating to a particular subject matter and having information relating to said subject matter;
extracting at least one features and at least one feature review relating to each of said plurality of user submissions;
generating statistical insights relating to said plurality of features and features reviews and other related information relating from said user submissions; and
generating a summary review pertaining to said plurality of user submissions, wherein said summary review includes information about each feature, feature review and statistical insights.
